(19) United States
(12) Patent Application Publication
(10) Pub. No.: US 2009/0280324 A1
(43) Pub. Date: Nov. 12, 2009

(54) Prepreg Nanoscale Fiber Films and Methods

(75) Inventors: Zhiyong Liang, Tallahassee, FL (US); Ben Wang, Tallahassee, FL (US); Chun Zhang, Tallahassee, FL (US)

Correspondence Address: SUTHERLAND ASBILL & BRENNAN LLP, 999 PEACHTREE STREET, N.E., ATLANTA, GA, 30309, US

(73) Assignee: FLORIDA STATE UNIVERSITY RESEARCH FOUNDATION, Tallahassee, FL (US)

(21) Appl. No.: 12/430,494

(22) Filed: Apr. 27, 2009

Related U.S. Application Data
(63) Continuation-in-part of application No. 11/751,655, filed on May 22, 2007.
(60) Provisional application No. 60/747,879, filed on May 22, 2006.
(60) Provisional application No. 61/048,383, filed on Apr. 28, 2008.

(51) Int. Cl. B32B 9/00; B29C 43/10; B29C 70/10

(52) U.S. Cl. 428/367; 264/571; 156/166; 977/742

(57) ABSTRACT

A method is provided for producing a prepreg nanoscale fiber film. The method includes providing a network of nanoscale fibers, impregnating the network of nanoscale fibers with a resin, and B-stage curing the resin. A method is also provided for producing a composite structure from the prepreg nanoscale fiber film.

### CROSS-REFERENCE TO RELATED APPLICATIONS

This application is a continuation-in-part of U.S. application Ser. No. 11/751,655, filed May 22, 2007, now pending, which claims benefit of U.S. Provisional Application No. 60/747,879, filed May 22, 2006. This application also claims benefit of U.S. Provisional Application No. 61/048,383, filed Apr. 28, 2008. These applications are incorporated herein by reference.

### BACKGROUND OF THE INVENTION

This invention relates generally to carbon nanotubes and nanofibers, and more particularly to prepreg composites that include nanoscale fibers.

Carbon nanotubes and nanofibers have both rigidity and strength properties, such as high elasticity, large elastic strains, and fracture strain sustaining capabilities. Such a combination of properties is generally not present in other materials. In addition, carbon nanotubes and nanofibers are some of the strongest fibers currently known. For example, the Young's Modulus of single-walled carbon nanotubes can be about 1 TPa, which is about five times greater than that for steel (about 200 GPa), yet the density of the carbon nanotubes is about 1.2 g/cm³ to about 1.4 g/cm³. The tensile strength of single-walled carbon nanotubes is generally in the range of about 50 GPa to about 200 GPa. This tensile strength indicates that composite materials made of carbon nanotubes and/or nanofibers could likely be lighter and stronger as compared to current high-performance carbon fiber-based composites.

Films of carbon nanotubes and nanofibers, or buckypapers, are a potentially important material platform for many applications. Typically, the films are thin, preformed sheets of well-controlled and dispersed porous networks of single-walled carbon nanotubes (SWNTs), multiple-walled carbon nanotubes (MWNTs), carbon nanofibers (CNFs), or mixtures thereof. The carbon nanotube and nanofiber film materials are flexible, light weight, and have mechanical, conductivity, and corrosion resistance properties desirable for numerous applications. The film form also makes nanoscale materials and their properties transferable to a macroscale material for ease of handling.

Pre-impregnation of reinforcement materials, or prepreg, may be used to produce intermediate materials for use in mass production of high quality composites in various industries. Prepreg materials provide processibility and quality to composite manufacturing processes, such as filament winding, automatic tape placement (ATP), vacuum bagging/autoclave, and hot-press. Prepreg also is an industrial technology for mass production of high quality fiber-reinforced composites. Exemplary fibers useful with prepreg include glass, carbon, Kevlar fibers, and other fibers which are easily wetted with resins during prepreg production.

Prepreg may comprise pre-impregnating fibers with polymer resin systems, such as epoxy and polyimide, by applying precisely controlled amounts of resin and B-stage curing (i.e., partially curing) the resin. Further layup and curing of the prepreg materials may then be carried out during later mass production of composite products. Such a process may be used in the production of aerospace composite parts, for example.

Conventional methods of directly mixing nanotubes with resins (e.g., for subsequent solvent casting, injection molding, or extrusion) have presented disadvantages. These problems are associated with the nanoscale fibers' very large surface area (˜1,500 m²/g) and the high viscosity of many resins and resin mixtures. In particular, these properties undesirably may limit the dispersion and alignment of the nanotubes in the resin, as well as limit the production of composite mixtures with high concentrations of the nanotubes.

It therefore would be desirable to provide improved processes and materials which minimize or avoid the aforementioned deficiencies.

### SUMMARY OF THE INVENTION

Methods are provided for producing prepreg nanoscale fiber films for use in composite applications. In certain embodiments, a method for producing a prepreg nanoscale fiber film comprises providing a network of nanoscale fibers, impregnating the network of nanoscale fibers with a resin, and B-stage curing the resin.

In one embodiment, the step of impregnating the network of nanoscale fibers comprises applying the resin onto the network of nanoscale fibers and applying a pressure to the resin to wet the network of nanoscale fibers with the resin. In a particular embodiment, the pressure is a vacuum pressure. In another embodiment, the step of impregnating the network of nanoscale fibers comprises applying the resin as a film onto the network of nanoscale fibers and applying a pressure to the resin to wet the network of nanoscale fibers with the resin. In yet another embodiment, the step of impregnating the network of nanoscale fibers comprises infiltrating the network of nanoscale fibers with the resin and compressing the network of nanoscale fibers and the resin. In certain embodiments, the step of impregnating the network of nanoscale fibers comprises immersing the network of nanoscale fibers in a solvent bath which comprises the resin.

In some embodiments, the step of providing the network of nanoscale fibers comprises suspending a plurality of nanoscale fibers in a liquid to form a suspension and then removing at least a portion of the liquid to form the network of nanoscale fibers. In one embodiment, the step of removing is conducted within a magnetic field effective to align the nanoscale fibers. In a particular embodiment, the step of removing comprises filtering the suspension by moving a filter membrane through the suspension and into transitory contact with a filter element, such that the nanoscale fibers are deposited directly on the filter membrane as the liquid flows through the filter membrane, thereby forming a continuous network of the nanoscale fibers. In some embodiments, the steps of impregnating and B-stage curing occur continuously along at least a portion of the continuous network of the nanoscale fibers.

In one embodiment, the network of the nanoscale fibers comprises a network of carbon nanotubes. In certain embodiments, the resin comprises an epoxy, a polyimide, a bismaleimide, a phenolic resin, a cyanate, or a combination thereof. In some embodiments, the resin is present in an amount from about 25 wt % to about 70 wt % based on the weight of the prepreg nanoscale fiber film.

In another aspect, a method for producing a composite is provided. In certain embodiments, the method comprises providing a prepreg nanoscale fiber film which comprises a B-stage cured resin and curing the B-stage cured resin. In one embodiment, the method further comprises placing the prepreg nanoscale fiber film adjacent to a structural material before curing the B-stage cured resin such that the prepreg nanoscale fiber film is attached to the structural material after curing the B-stage cured resin.

In one embodiment, the structural material comprises a foam, a honeycomb structure, a glass fiber laminate, a carbon fiber laminate, a Kevlar fiber composite, a polymeric article, or a combination thereof. In a particular embodiment, the prepreg nanoscale fiber film comprises a network of aligned nanoscale fibers. In another embodiment, the prepreg nanoscale fiber film comprises a network of carbon nanotubes. In yet another embodiment, the resin comprises an epoxy, a polyimide, a bismaleimide, a phenolic resin, a cyanate, or a combination thereof.

In yet another aspect, a prepreg nanoscale fiber film is provided. In certain embodiments, the prepreg nanoscale fiber film comprises a network of nanoscale fibers and a B-stage cured resin impregnated into the network of nanoscale fibers.

In one embodiment, the network of nanoscale fibers comprises a network of carbon nanotubes. In a particular embodiment, the resin comprises an epoxy, a polyimide, a bismaleimide, a phenolic resin, a cyanate, or a combination thereof.

In certain embodiments, the resin is present in the composite film in an amount from about 25 wt % to about 70 wt % based on the weight of the prepreg nanoscale fiber film.

### BRIEF DESCRIPTION OF THE DRAWINGS

FIG. 1 is a process flow diagram illustrating one embodiment of the method for producing a prepreg nanoscale fiber film.

FIG. 2 is a process flow diagram illustrating another embodiment of the method for producing a prepreg nanoscale fiber film.

FIG. 3 is a process flow diagram illustrating one embodiment of the method for producing a composite structure from a prepreg buckypaper.

### DESCRIPTION OF THE INVENTION

Methods have been developed to produce prepreg nanoscale fiber films (e.g., buckypaper prepreg material) for use in composite production applications. These methods transform the nanoscale fiber materials from a loose powder form to a convenient prepreg form for industrial applications, thus combining the processibility and quality control advantages of nanoscale fiber films and prepreg technologies. Prepreg nanoscale fiber films are more environmentally friendly and potentially safer for handling and transportation than loose nanoscale fibers, since the nanoscale fibers are embedded in a resin matrix, thereby reducing or eliminating airborne nanoscale fibers. In addition, the methods convert buckypaper, which may typically require careful handling as a thin film, to a more easily handled prepreg nanoscale fiber film for later composite production.

In addition to improving handling of nanoscale fiber materials, the methods also provide technical solutions to scale-up challenges associated with utilizing nanoscale fiber materials for composite mass production, while reducing manufacturing cost. These methods also achieve impregnation of the dense networks of nanoscale fibers in buckypaper with resin. Furthermore, the prepreg buckypaper methods provide good dispersion, alignment, and high loading of nanoscale fibers, for use in mass production of high performance composite applications.

Moreover, the methods provide resin content control and substantially complete or complete resin impregnation of the thin (usually 5-100 microns), nanoscale porous buckypaper structures. In addition, the methods may use larger buckypapers (e.g., 8 inches×8 inches or larger), which avoid or reduce edge effects, such as edge break and resin rich problems, that may result from using smaller buckypapers.

The buckypaper prepreg materials that are made as described herein may be used alone to make nanocomposites or combined with conventional fiber-reinforced composites. The buckypaper/resin prepreg materials may be used in aerospace, automotive, and electronics applications, where carbon nanoscale fiber materials improve structural properties and provide composite materials that have multifunctional performance characteristics, such as electrical and thermal conductivity, EMI shielding, and lightning strike protection.

In addition, the prepreg nanoscale fiber films may increase the use of nanoscale fiber films in various applications. Prepreg may be used as a standard material platform for many current composite fabrication processes due to its processibility and high quality, particularly for mass production of high-end aerospace and electronic products.

As used herein, the terms “comprise,” “comprising,” “include,” and “including” are intended to be open, non-limiting terms, unless the contrary is expressly indicated.

### The Prepreg Nanoscale Fiber Film and Methods for Producing the Prepreg Nanoscale Fiber Film

The prepreg nanoscale fiber films comprise a network of nanoscale fibers and a B-stage cured resin attached to a portion of the network of nanoscale fibers. In one embodiment, the prepreg nanoscale fiber film comprises a network of nanoscale fibers and a B-stage cured resin impregnated into the network of nanoscale fibers.

In various embodiments, the resin comprises epoxy (e.g., EPON 862), polyimide, bismaleimide, phenolic resin, cyanate, a combination thereof, or the like.

In some embodiments, the resin may be mixed with a solvent (e.g., acetone or alcohol), a curing agent, or other additives known in the art.

In some embodiments, the resin in the prepreg nanoscale fiber film is present in a range from about 25 wt % to about 70 wt %, for example in a range from about 40 wt % to about 65 wt %, and for example in a range from about 45 wt % to about 55 wt % based on the weight of the prepreg nanoscale fiber film.

In one embodiment, the prepreg nanoscale fiber film is made by a method that includes the steps of (i) producing or otherwise obtaining a network of nanoscale fibers, (ii) impregnating the network of nanoscale fibers with a resin, and (iii) B-stage curing the resin. As used herein, “B-stage curing” refers to the partial curing of a resin such that the resin has substantially lost its flowability and has an overall degree of curing at a very low level (e.g., less than about 5% to about 25%). A B-stage cured resin is not fully cured. B-stage cured resin may be kept at an appreciable stickiness or tackiness and flexibility for ease of handling in use.

When it is desired, B-stage cured resin may be heated to melt it back to a low viscosity and then cured to be used to fabricate composites. As used herein, “curing a B-stage cured resin” refers to the curing of all or a substantial portion of the B-stage cured resin such that the resin is “fully cured” and thus, may be used as a composite material.

In one embodiment, the step of impregnating includes applying (i.e., disposing) a resin in liquid form directly onto a network of nanoscale fibers and then applying a pressure to the resin to wet the network of nanoscale fibers with the resin. For example, the resin may be poured onto a first surface of the network of nanoscale fibers and then a vacuum may be applied adjacent to a second surface of the network of nanoscale fibers to pull the resin into the interstices in the network of nanoscale fibers. In another instance, the resin may be poured onto a first surface of the network of nanoscale fibers and then a compressive force directed towards the first surface and/or a second surface of the network of nanoscale fibers to press the resin into the interstices in the network of nanoscale fibers. In another embodiment, the step of impregnating includes applying the resin as a film onto the network of nanoscale fibers and then applying a pressure to the resin to wet the network of nanoscale fibers with the resin. In yet another embodiment, the step of impregnating the nanoscale fiber film comprises infiltrating the nanoscale fiber film with the resin and then compressing the infiltrated nanoscale fiber film. In one specific embodiment, the compressing step comprises placing the infiltrated nanoscale fiber film in a mold and then hot pressing it. The application of pressure to the resin may be by use of vacuum pressure (e.g., applied on the side opposite the applied resin on the network of nanoscale fibers) or compressive pressure (e.g., directed on one or two sides of the network of nanoscale fibers). In one embodiment, the method includes applying a pressure up to about 20 MPa.

In one embodiment, the step of impregnating includes immersing the network of nanoscale fibers in solvent bath which comprises the resin. For instance, a network of nanoscale fibers in a sheet form may be dipped into a container holding a resin solution such that the resin is absorbed into the interstices of the network of nanoscale fibers and/or adheres to the network of nanoscale fibers. One skilled in the art will be able to select suitable solvent, melt, and/or film pre-impregnation methods, materials and process conditions.

In various embodiments, the method of producing the prepreg includes applying (e.g., affixing or disposing) to one or both sides of the resin-impregnated nanoscale fiber film a release paper known in the art. For instance, the release paper may include a Teflon or wax coated sheet.

In another embodiment, the step of impregnating comprises (i) placing a filter adjacent to a first surface of a nanoscale fiber film, (ii) infiltrating the nanoscale fiber film with a fluid resin or resin solution through a second surface of the nanoscale fiber film opposing (distal to) the first surface, and (iii) pulling a vacuum through the filter at the first surface, applying a compressive pressure on the resin at the second surface, or applying both the vacuum and the compression, to cause at least a portion of the resin to pass into or through (the pores in) the nanoscale fiber film.

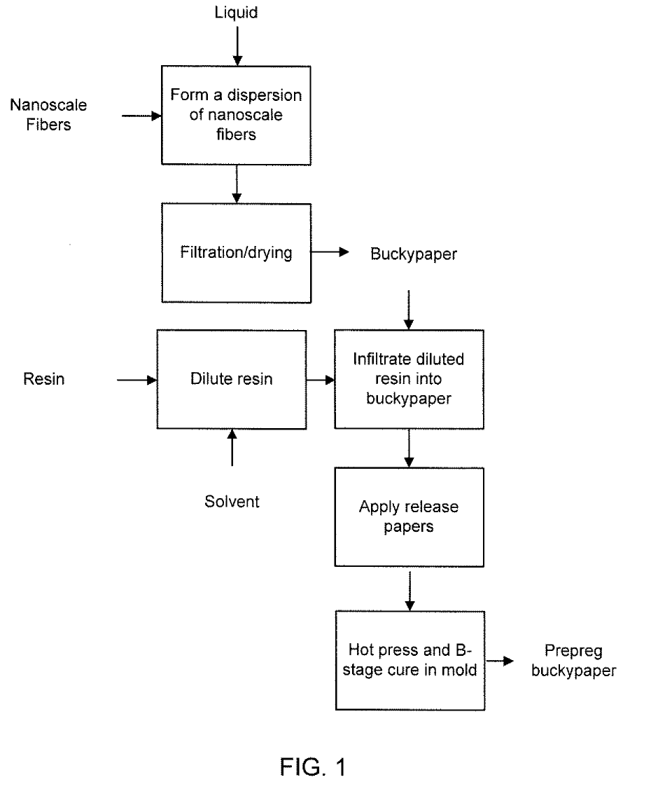

FIG. 1 illustrates an embodiment of a process for producing a prepreg nanoscale fiber film by dispersing nanoscale fibers in a liquid to form a dispersion; filtering the dispersion to form buckypaper; diluting a resin with a solvent to reduce its viscosity; infiltrating the diluted resin through the buckypaper under pressure or vacuum; placing release papers on each side of the resin-infiltrated buckypaper; and hot pressing the release paper and resin-infiltrated buckypaper “sandwich” in a mold to B-stage cure the resin.

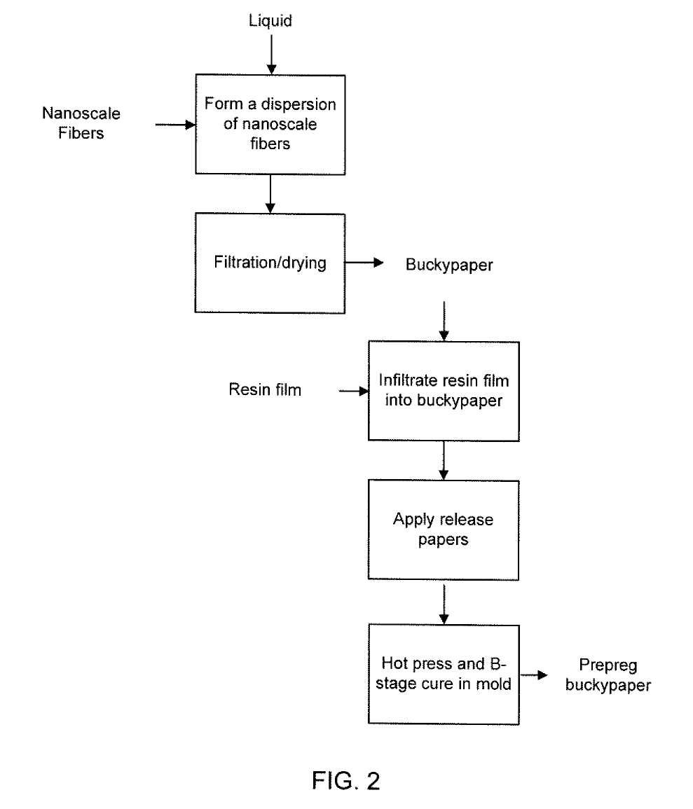

FIG. 2 illustrates another embodiment of a process for producing a prepreg nanoscale fiber film by dispersing nanoscale fibers in a liquid to form a dispersion; filtering the dispersion to form buckypaper; applying the resin as a film onto the buckypaper and infiltrating the resin film through the buckypaper under pressure or vacuum; placing release papers on each side of the resin-infiltrated buckypaper; and hot pressing the release paper and resin-infiltrated buckypaper “sandwich” in a mold to B-stage cure the resin.

### The Nanoscale Fiber Film

The prepreg nanoscale fiber films comprise a nanoscale fiber film. The nanoscale fiber film may be made by essentially any suitable process known in the art.

In some embodiments, the nanoscale fiber film materials are made by a method that includes the steps of (1) suspending SWNTs, MWNTs, and/or CNF in a liquid, and then (2) removing a portion of the liquid to form the film material. In one embodiment, all or a substantial portion of the liquid is removed. As seen herein, “a substantial portion” means more than 50%, typically more than 70, 80%, 90%, or 99% of the liquid. The step of removing the liquid may include a filtration process, vaporizing the liquid, or a combination thereof. For example, the liquid removal process may include, but is not limited to, evaporation (ambient temperature and pressure), drying, lyophilization, heating to vaporize, or using a vacuum.

The liquid includes a non-solvent, and optionally may include a surfactant (such as Triton X-100, Fisher Scientific Company, NJ) to enhance dispersion and suspension stabilization. As used herein, the term “non-solvent” refers to liquid media that essentially are non-reactive with the nanotubes and in which the nanotubes are virtually insoluble. Examples of suitable non-solvent liquid media include water, and volatile organic liquids, such as acetone, ethanol, methanol, n-hexane, benzene, dimethyl formamide, chloroform, methylene chloride, acetone, or various oils. Low-boiling point liquids are typically preferred so that the liquid can be easily and quickly removed from the matrix material. In addition, low viscosity liquids can be used to form dense conducting networks in the nanoscale fiber films.

For example, the films may be made by dispersing nanotubes in water or a non-solvent to form suspensions and then filtering the suspensions to form the film materials. In one embodiment, the nanoscale fibers are dispersed in a low viscosity medium such as water or a low viscosity non-solvent to make a suspension and then the suspension is filtered to form dense conducting networks in thin films of SWNT, MWNT, CNF or their mixtures. Other suitable methods for producing nanoscale fiber film materials are disclosed in U.S. patent application Ser. No. 10/726,074, entitled “System and Method for Preparing Nanotube-based Composites;” U.S. Patent Application Publication No. 2008/0280115, entitled “Method for Fabricating Macroscale Films Comprising Multiple-Walled Nanotubes;” and U.S. Pat. No. 7,459,121 to Liang et al., which are incorporated herein by reference.

Additional examples of suitable methods for producing nanoscale fiber film materials are described in S. Wang, Z. Liang, B. Wang, and C. Zhang, “High-Strength and Multifunctional Macroscopic Fabric of Single-Walled Carbon Nanotubes,” Advanced Materials, 19, 1257-61 (2007); Z. Wang, Z. Liang, B. Wang, C. Zhang and L. Kramer, “Processing and Property Investigation of Single-Walled Carbon Nanotube (SWNT) Buckypaper/Epoxy Resin Matrix Nanocomposites,” Composite, Part A: Applied Science and Manufacturing, Vol. 35 (10), 1119-233 (2004); and S. Wang, Z. Liang, G. Pham, Y. Park, B. Wang, C. Zhang, L. Kramer, and P. Funchess, “Controlled Nanostructure and High Loading of Single-Walled Carbon Nanotubes Reinforced Polycarbonate Composite,” Nanotechnology, Vol. 18, 095708 (2007).

In one embodiment, the step of removing comprises filtering the suspension by moving a filter membrane through the suspension, into transitory contact with a filter element, such that the nanoscale fibers are deposited directly on the filter membrane as the liquid flows through the filter membrane, thereby forming a continuous network of the nanoscale fibers. In a particular embodiment, the steps of impregnating and B-stage curing occur continuously along at least a portion of the continuous network of the nanoscale fibers. Thus, continuous production of prepreg materials may be carried out.

In certain embodiments, the nanoscale fiber films are commercially available nanoscale fiber films. For example, the nanoscale fiber films may be preformed nanotube sheets made by depositing synthesized nanotubes into thin sheets (e.g., nanotube sheets from Nanocomp Technologies Inc., Concord, N.H.).

In other embodiments, the nanoscale fiber films are produced by stretching synthesized nanotube arrays to directly form nanotube networks.

In one embodiment, the network of nanoscale fibers consists essentially of carbon nanotubes. In one embodiment, the carbon nanotubes are single walled carbon nanotubes.

The nanotubes and CNFs may be randomly dispersed, or may be aligned, in the produced films. In one embodiment, the fabrication method further includes aligning the nanotubes in the nanoscale fiber film. For example, aligning the nanotubes may be accomplished using in situ filtration of the suspensions in high strength magnetic fields, as described for example, in U.S. Patent Application Publication No. 2005/0239948 to Haik et al. In various embodiments, good dispersion and alignment are realized in buckypapers materials, which assists the production of high nanoscale fiber content (i.e., greater than 20 wt. %) buckypaper for high performance composites materials.

In various embodiments, the films have an average thickness from about 5 to about 100 microns thick with a basis weight (i.e., area density) of about 20 g/m² to about 50 g/m².

As used herein, the term “nanoscale fibers” refers to a thin, greatly elongated solid material, typically having a cross-section or diameter of less than 500 nm. As used herein, the term “film” refers to thin, preformed sheets of well-controlled and dispersed porous networks of SWNTs, MWNTs materials, carbon nanofibers CNFs, or mixtures thereof. In a preferred embodiment, the nanoscale fibers comprise or consist of carbon nanotubes, including both SWNTs and MWNT. SWNTs typically have small diameters (˜1-5 nm) and large aspect ratios, while MWNTs typically have large diameters (˜5-200 nm) and small aspect ratios. CNFs are filamentous fibers resembling whiskers of multiple graphite sheets or MWNTs.

As used herein, the terms “carbon nanotube” and the shorthand “nanotube” refer to carbon fullerene, a synthetic graphite, which typically has a molecular weight between about 840 and greater than 10 million grams/mole. Carbon nanotubes are commercially available, for example, from Unidym Inc. (Houston, Tex. USA), or can be made using techniques known in the art.

The nanotubes optionally may be opened or chopped, for example, as described in U.S. Patent Application Publication No. 2006/0017191 A1.

The nanotube and nanofibers optionally may be chemically modified or coated with other materials to provide additional functions for the films produced. For example, in some embodiments, the carbon nanotubes and CNFs may be coated with metallic materials to enhance their conductivity.

Methods for Producing a Composite from the Prepreg Nanoscale Fiber Film

The prepreg nanoscale fiber films made as described herein may be used alone or with other materials to make composites. Applications for the prepreg nanotube composites described herein include structural components for fabrication of civilian and military vehicles, aerospace vehicles, and electronic devices, including communications equipment and consumer electronics products. In one example, the prepreg composites described herein may be used to make shielding devices as described in U.S. Patent Application Publication No. 2008/0057265 A1.

In one embodiment, the method for producing a composite comprises providing a prepreg nanoscale fiber film which comprises a B-stage cured resin and then curing the B-stage cured resin, yielding a composite material.

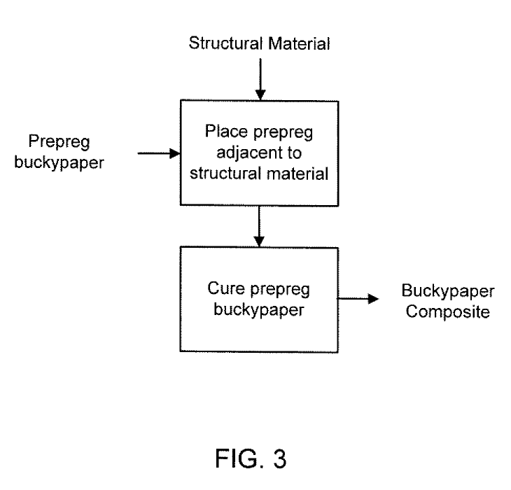

In a specific embodiment, illustrated in FIG. 3, the prepreg nanoscale fiber film is placed adjacent to a structural material before curing the B-stage cured resin such that the prepreg nanoscale fiber film becomes attached (e.g., integrated with) to the structural material after curing the B-stage cured resin.

In certain embodiments, the method for producing a composite comprises providing a prepreg nanoscale fiber film, sandwiched between release papers, removing the release papers, and then curing the B-stage cured resin. In one embodiment, the method further comprises storing or transporting the prepreg nanoscale fiber film sandwiched between release papers, before B-stage curing and/or attaching the prepreg nanoscale fiber film to a structural material.

The step of combining the prepreg nanoscale fiber film with one or more structural materials to form a composite may be done using a variety of techniques known in the art that suitably preserve the mechanical integrity of the nanoscale fiber film. A wide variety of structural materials are envisioned for use in the construction of the composite. The structural materials may include essentially any substrate or structure. For example, the structural material may include foams, honeycombs, glass fiber laminates, carbon fiber laminates, Kevlar fiber composites, polymeric articles, or combinations thereof. As used herein, “polymeric articles” refers to a film, sheet, block, woven, or nonwoven fiberous material, or any other shaped article comprising a polymer. Non-limiting examples of suitable structural materials include polyurethanes, silicones, fluorosilicones, polycarbonates, ethylene vinyl acetates, acrylonitrile-butadiene-styrenes, polysulfones, acrylics, polyvinyl chlorides, polyphenylene ethers, polystyrenes, polyamides, nylons, polyolefins, poly(ether ether ketones), polyimides, polyetherimides, polybutylene terephthalates, polyethylene terephthalates, fluoropolymers, polyesters, acetals, liquid crystal polymers, polymethylacrylates, polyphenylene oxides, polystyrenes, epoxies, phenolics, chlorosulfonates, polybutadienes, buna-N, butyls, neoprenes, nitriles, polyisoprenes, natural rubbers, and copolymer rubbers such as styrene-isoprene-styrenes, styrene-butadiene-styrenes, ethylene-propylenes, ethylene-propylene-diene monomers (EPDM), nitrile-butadienes, and styrene-butadienes (SBR), and copolymers and blends thereof. Any of the forgoing materials may be used unfoamed or, if required by the application, blown or otherwise chemically or physically processed into an open or closed cell foam.

The methods and composites described above will be further understood with reference to the following non-limiting example.

Example: Prepreg Nanoscale Fiber Film

A prepreg nanoscale fiber film of randomly dispersed SWNT buckypaper/EPON 862 (Shell Chemicals) was made using a solvent impregnation method. The SWNTs used were purified SWNTs from Carbon Nanotechnology (CNI, Houston, Tex.). EPON 862 resin and EPI Cure W curing agent were mixed in a weight ratio of 100:26.4 and dissolved in acetone. A thin film of the resin was created on a flat Teflon release film (Airtech, Huntington Beach) by casting the mixture and vaporizing the acetone to form a film about 2 to about 5 times the thickness of the buckypaper. A SWNT buckypaper film was pressed on the resin film and another release film was added on the top of impregnated buckypaper to sandwich the impregnated buckypaper. Then, the impregnated buckypaper and release films were sealed in a vacuum bag and full vacuum (i.e., 14.7 psi) was applied. The buckypaper/resin “sandwich” was placed in an oven at a temperature of 100° C. After heating for about 30 to about 60 minutes, the resin was B-stage cured and a buckypaper/EPON 862 resin prepreg resulted. The buckypaper/EPON 862 resin prepreg had a resin content of 52 wt %.

Publications cited herein and the material for which they are cited are specifically incorporated by reference. Modifications and variations of the methods and devices described herein will be obvious to those skilled in the art from the foregoing detailed description. Such modifications and variations are intended to come within the scope of the appended claims.

We claim:

1. A method for producing a prepreg nanoscale fiber film comprising:
providing a network of nanoscale fibers;
impregnating the network of nanoscale fibers with a resin; and
B-stage curing the resin.

2. The method of claim 1, wherein impregnating the network of nanoscale fibers comprises applying the resin in a fluid form onto the network of nanoscale fibers and applying a pressure to the resin to wet the network of nanoscale fibers with the resin.

3. The method of claim 2, wherein the pressure comprises a vacuum pressure.

4. The method of claim 1, wherein impregnating the network of nanoscale fibers comprises applying the resin in a film form onto the network of nanoscale fibers and applying a pressure to the resin to wet the network of nanoscale fibers with the resin.

5. The method of claim 1, wherein impregnating the network of nanoscale fibers comprises infiltrating the network of nanoscale fibers with the resin and compressing the network of nanoscale fibers and the resin.

6. The method of claim 1, wherein impregnating the network of nanoscale fibers comprises immersing the network of nanoscale fibers in a solution which comprises the resin and a solvent for the resin.

7. The method of claim 1, wherein providing the network of nanoscale fibers comprises:
dispersing a plurality of nanoscale fibers in a liquid to form a suspension; and
removing at least a portion of the liquid in a controlled manner to form the network of nanoscale fibers.

8. The method of claim 7, wherein removing the liquid is conducted within a magnetic field effective to align the nanoscale fibers forming the network.

9. The method of claim 7, wherein removing the liquid comprises filtering the suspension.

10. The method of claim 9, wherein the filtering comprises moving a filter membrane through the suspension, into transitory contact with a filter element, such that the nanoscale fibers are deposited directly on the filter membrane as the liquid flows through the filter membrane, thereby forming a continuous network of the nanoscale fibers.

11. The method of claim 10, wherein the steps of impregnating and B-stage curing occur continuously along at least a portion of the continuous network of the nanoscale fibers.

12. The method of claim 1, wherein the network of the nanoscale fibers comprises carbon nanotubes.

13. The method of claim 1, wherein the resin comprises an epoxy, a polyimide, a bismaleimide, a phenolic resin, a cyanate, or a combination thereof.

14. The method claim 1, wherein the resin is present in an amount from about 25 wt % to about 70 wt % based on the weight of the prepreg nanoscale fiber film.

15. A method for producing a composite material comprising:
providing a prepreg nanoscale fiber film which comprises a B-stage cured resin; and
curing the B-stage cured resin.

16. The method of claim 15, further comprising placing the prepreg nanoscale fiber film adjacent to a structural material before curing the B-stage cured resin such that the prepreg nanoscale fiber film becomes attached to the structural material upon curing the B-stage cured resin.

17. The method of claim 16, wherein the structural material comprises a foam, a honeycomb structure, a glass fiber laminate, a carbon fiber laminate, a Kevlar fiber composite, a polymeric article, or a combination thereof.

18. The method of claim 15, wherein the prepreg nanoscale fiber film comprises a network of aligned nanoscale fibers.

19. The method of claim 15, wherein the prepreg nanoscale fiber film comprises a network of carbon nanotubes.

20. The method of claim 15, wherein the resin comprises an epoxy, a polyimide, a bismaleimide, a phenolic resin, a cyanate, or a combination thereof.

21. A prepreg nanoscale fiber film comprising:
a network of nanoscale fibers; and
a B-stage cured resin impregnated into the network of nanoscale fibers.

22. The prepreg nanoscale fiber film of claim 21, wherein the network of nanoscale fibers comprises a network of carbon nanotubes.

23. The prepreg nanoscale fiber film of claim 21, wherein the resin comprises epoxy, polyimide, bismaleimide, phenolic resin, cyanate, or a combination thereof.

24. The prepreg nanoscale fiber film of claim 21, wherein the resin is present in an amount from about 25 wt % to about 70 wt % based on the weight of the prepreg nanoscale fiber film.
